(19) United States
(12) Patent Application Publication
(10) Pub. No.: US 2021/0273252 A1
(43) Pub. Date: Sep. 2, 2021

(54) FLOW BATTERY

(71) Applicant: Panasonic Intellectual Property Management Co., Ltd., Osaka (JP)

(72) Inventors: SHUJI ITO, Nara (JP); YU OTSUKA, Osaka (JP); YUKA OKADA, Hyogo (JP)

(21) Appl. No.: 17/321,558

(22) Filed: May 17, 2021

Related U.S. Application Data
(63) Continuation of application No. PCT/JP2019/024409, filed on Jun. 20, 2019.

(30) Foreign Application Priority Data
Dec. 27, 2018 (JP) 2018-246229

(51) Int. Cl. H01M 8/18; H01M 8/02; H01M 8/1023; H01M 8/1039

(52) U.S. Cl. CPC H01M 8/188; H01M 8/1039; H01M 8/1023; H01M 8/02

(57) ABSTRACT

A flow battery includes a first nonaqueous liquid; a first electrode at least in part in contact with the first nonaqueous liquid; a second electrode that is a counter electrode with respect to the first electrode; and a separator that separates the first electrode and the second electrode from each other. The separator is made of an ion conductive polymer that has a crosslink structure containing an aromatic ring, the ion conductive polymer has an alkyl main chain that contains a plurality of acidic groups, and at least a subset of the plurality of the acidic groups forms salts with metal ions.

### BACKGROUND

### 1. Technical Field

The present disclosure relates to a flow battery.

### 2. Description of the Related Art

Japanese Unexamined Patent Application Publication (Translation of PCT Application) No. 2014-524124 discloses a redox flow battery system that includes an energy reservoir containing a redox mediator.

International Publication No. 2016/208123 discloses a flow battery in which a redox species is used.

C. Jia et al., Sci. Adv., 2015, 1, e1500886 discloses a flow battery that has a separator made with a polymeric solid electrolyte.

### SUMMARY

One non-limiting and exemplary embodiment provides a flow battery that includes a polymeric electrolyte that does not easily swell upon contact with a nonaqueous liquid and conducts metal ions.

In one general aspect, the techniques disclosed here feature a flow battery. The flow battery includes a first nonaqueous liquid; a first electrode at least in part in contact with the first nonaqueous liquid; a second electrode that is a counter electrode with respect to the first electrode; and a separator that separates the first electrode and the second electrode from each other. The separator is made of an ion conductive polymer that has a crosslink structure containing an aromatic ring, the ion conductive polymer has an alkyl main chain that contains a plurality of acidic groups, and at least a subset of the plurality of the acidic groups forms salts with metal ions.

According to certain aspects of the present disclosure, there is provided a flow battery that includes a polymeric electrolyte that does not swell upon contact with a nonaqueous liquid easily and conducts metal ions.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an outline structure of a flow battery according to Embodiment 1;

FIG. 2 is a block diagram illustrating an outline structure of a flow battery according to Embodiment 2; and

FIG. 3 is a schematic diagram illustrating an outline structure of a flow battery according to Embodiment 3.

### DETAILED DESCRIPTION

### Underlying Knowledge Forming Basis of the Present Disclosure

Nonaqueous flow batteries may have a separator made of an inorganic solid electrolyte that conducts lithium ions. Making such a separator large in area and thin in thickness, however, is a difficult task because the separator would be brittle because of inflexibility of the inorganic solid electrolyte. A separator made of a polymeric solid electrolyte, which is flexible, can dissolve in or swell with the electrolytes. Once the separator dissolves or swells, the electrolyte on the positive electrode side and that on the negative electrode side mix together, and this can affect the charge-discharge characteristics of the nonaqueous flow battery significantly. The inventors conducted extensive research and conceived a flow battery that includes a polymeric electrolyte that does not easily swell upon contact with a nonaqueous liquid and conducts metal ions.

### Overview of Aspects of the Present Disclosure

A flow battery according to a first aspect of the present disclosure includes:
a first nonaqueous liquid;
a first electrode at least in part in contact with the first nonaqueous liquid;
a second electrode that is a counter electrode with respect to the first electrode; and
a separator that separates the first electrode and the second electrode from each other.

The separator is made of an ion conductive polymer that has a crosslink structure containing an aromatic ring,
the ion conductive polymer has an alkyl main chain that contains a plurality of acidic groups, and
at least a subset of the plurality of the acidic groups forms salts with metal ions.

In the first aspect, a flow battery is provided that does not easily swell upon contact with a nonaqueous liquid and conducts metal ions.

In a second aspect of the present disclosure, for example, the metal ions in the flow battery according to the first aspect may include at least one species selected from the group consisting of alkali metal ions and alkaline earth metal ions.

In a third aspect of the present disclosure, for example, the metal ions in the flow battery according to the first aspect may include at least one species selected from the group consisting of lithium ions, sodium ions, potassium ions, magnesium ions, and calcium ions.

In a fourth aspect of the present disclosure, for example, the metal ions in the flow battery according to the third aspect may be lithium ions.

In the first to fourth aspects, a flow battery is realized that has a large charge capacity and maintains its charge-discharge characteristics for an extended period of time. Using such a first nonaqueous liquid, furthermore, allows the use of a mediator that combines solubility in nonaqueous liquids, high capacity, and good reversibility.

In a fifth aspect of the present disclosure, for example, the acidic groups in the flow battery according to any one of the first to fourth aspects may include at least one selected from the group consisting of a sulfo group, a carboxyl group, a trifluoromethanesulfonylimide group, a fluorosulfonylimide group, a fluorosulfonic acid group, a phosphonic acid group, a fluorophosphonic acid group, and a phosphoric acid group. Using any of these acidic groups helps give the separator high ionic and electrical conductivity.

In a sixth aspect of the present disclosure, for example, the acidic groups in the flow battery according to any one of the first to fifth aspects may include the sulfo group. The sulfo group helps increase the ion-exchange capacity of the ion conductive polymer.

In a seventh aspect of the present disclosure, for example, the ion conductive polymer in the flow battery according to any one of the first to sixth aspects may include a structure represented by general formula (1). In formula (1), m and n are each independently an integer larger than or equal to 1. Such an ion conductive polymer does not easily swell upon contact with a nonaqueous liquid and conducts metal ions.

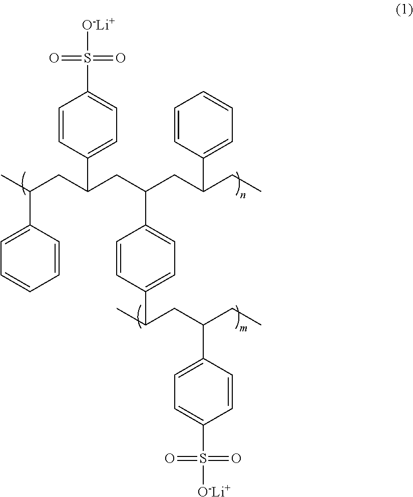

In an eighth aspect of the present disclosure, for example, the first nonaqueous liquid in the flow battery according to any one of the first to seventh aspects may contain, as a solvent, a compound that has at least one selected from the group consisting of a carbonate group and an ether group.

In a ninth aspect of the present disclosure, for example, the first nonaqueous liquid in the flow battery according to any one of the first to seventh aspects may contain, as a solvent, at least one selected from the group consisting of propylene carbonate, ethylene carbonate, dimethyl carbonate, ethyl methyl carbonate, and diethyl carbonate.

In a tenth aspect of the present disclosure, for example, the first nonaqueous liquid in the flow battery according to any one of the first to seventh aspects may contain, as a solvent, at least one selected from the group consisting of dimethoxyethane, dibutoxyethane, diglyme, triglyme, tetraglyme, tetrahydrofuran, 2-methyltetrahydrofuran, 2,5-dimethyltetrahydrofuran, 1,3-dioxolane, and 4-methyl-1,3-dioxolane.

In the eighth to tenth aspects, the flow battery has a large charge-discharge capacity.

In an eleventh aspect of the present disclosure, for example, the flow battery according to any one of the first to tenth aspects may further include a first electrode mediator; a first active material; and a first circulator configured to circulate the first nonaqueous liquid between the first electrode and the first active material. The first nonaqueous liquid may contain the first electrode mediator. The first electrode mediator may be oxidized or reduced by the first electrode, and the first electrode mediator may be oxidized or reduced by the first active material. In such a configuration, the active material can be a high-potential one that receives and releases inserted lithium or other alkali metal, for example, through chemical reactions with the first nonaqueous liquid and the first electrode mediator. A flow battery is therefore realized that has a large charge capacity and maintains its charge-discharge characteristics for an extended period of time.

In a twelfth aspect of the present disclosure, for example, the flow battery according to any one of the first to eleventh aspects may further include a second nonaqueous liquid; a second electrode mediator; a second active material; and a second circulator configured to circulate the second nonaqueous liquid between the second electrode and the second active material. The second nonaqueous liquid may contain the second electrode mediator, and at least part of the second electrode may be in contact with the second nonaqueous liquid. The second electrode mediator may be oxidized or reduced by the second electrode, and the second electrode mediator may be oxidized or reduced by the second active material. In such a configuration, a flow battery is realized that has a large charge capacity and maintains its charge-discharge characteristics for an extended period of time.

In the following, embodiments of the present disclosure are described with reference to drawings.

### Embodiment 1

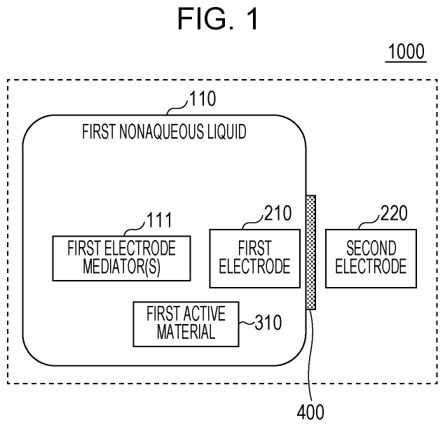

FIG. 1 is a block diagram illustrating an outline structure of a flow battery 1000 according to Embodiment 1 by way of example.

The flow battery 1000 according to Embodiment 1 includes a first nonaqueous liquid 110, a first electrode 210, a second electrode 220, a first electrode mediator 111, and a separator 400.

The first nonaqueous liquid 110 contains the first electrode mediator 111 and metal ions dissolved therein.

At least part of the first electrode 210 is in contact with the first nonaqueous liquid 110.

The second electrode 220 is a counter electrode with respect to the first electrode 210.

The separator 400 separates the first and second electrodes 210 and 220 from each other.

The separator 400 is made of an electrolyte. The electrolyte can be a solid electrolyte. The electrolyte of which the separator 400 is made is an ion conductive polymer. The ion conductive polymer has a crosslink structure including an aromatic ring and also has an alkyl main chain including multiple acidic groups. In the ion conductive polymer, at least a subset of the acidic groups is in the form of a salt with at least one species of metal ion. The crosslink structure may be an aromatic ring.

The alkyl main chain may have multiple aromatic rings. The acidic groups may be bound to each one of the aromatic rings or may be bound to a selected subset of the aromatic rings. The number of bound acidic groups per aromatic ring is not critical; one aromatic ring may have one or two or more acidic groups bound thereto.

Examples of the acidic groups include a sulfo group, a carboxyl group, a trifluoromethanesulfonylimide group, a fluorosulfonylimide group, a fluorosulfonic acid group, a phosphonic acid group, a fluorophosphonic acid group, and a phosphoric acid group. Fluorinating the ion-exchanging sites encourages the release of the metal ions, helping improve electrical conductivity. Using phosphonic acid groups results in more ion-exchanging sites present, helping improve electrical conductivity. The ion conductive polymer may be a polymer that includes a sulfone-bearing aromatic ring. Using a polymer that includes a sulfone-bearing aromatic ring helps increase the ion-exchange capacity of the ion conductive polymer. This leads to easier conduction of ions and improved electrical conductivity.

In this configuration, a flow battery is realized that has a large charge capacity and maintains its charge-discharge characteristics for an extended period of time.

The ion conductive polymer forming the separator 400 has a three-dimensional structure in which linear chains of polystyrene are crosslinked together by aromatic rings. By virtue of this, the separator 400 does not easily swell even if it comes into contact with the first nonaqueous liquid 110, and conducts metal ions. The crossover of the first electrode mediator 111 may also be reduced because swelling-induced dilatation of pores in the separator 400 is limited. Greater flexibility, furthermore, is allowed in selecting the first nonaqueous liquid 110 and the first electrode mediator 111. The limits to which the charge and discharge potentials should be controlled are therefore expanded, helping increase the charge capacity of the flow battery 1000.

This configuration also contributes to realizing a flow battery that has a large charge capacity and maintains its charge-discharge characteristics for an extended period of time.

The three-dimensional structure, i.e., linear chains of polystyrene crosslinked by aromatic rings, of the ion conductive polymer forming the separator 400 also gives the separator 400 adequate mechanical strength. By virtue of this, a flow battery 1000 is realized in which the separator 400 can be made large in area and thin in thickness.

The separator 400 serves as an electrolytic membrane through which ions can travel. The thickness of the electrolytic membrane is not critical. The electrolytic membrane may be a thin film.

The polymer contained in the separator 400 in the flow battery 1000 according to Embodiment 1 includes a structure represented by formula (1) below. In formula (1) below, each of m and n is independently an integer larger than or equal to 1. There is no particular upper limit to m and n.

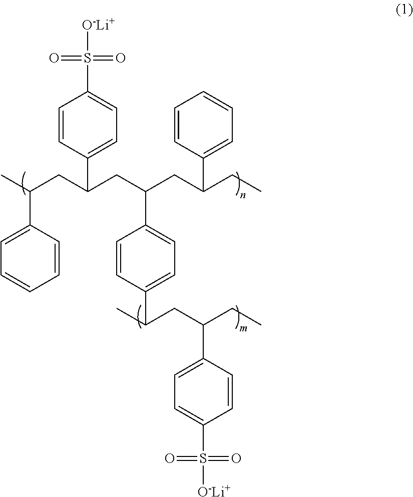

An ion conductive polymer having a structure represented by formula (1) contains anionic sulfone groups as acidic groups. Sulfone groups can fasten metal ions to an electrolyte with their capability of holding metal ions. A proposed mechanism for ionic conduction through a polymeric electrolyte that can hold metal ions is that sulfone groups provide sites for the exchange of the metal ions and allow solvated metal ions to move therebetween.

In general, the electrical conductivity of a polymeric solid electrolyte can be improved by increasing the ion-exchange capacity of the ion conductive polymer. It is, however, known that such an electrolyte loses its mechanical strength once it swells with and/or dissolves in a polar solvent.

The metal compound used to introduce the metal ions into the ion conductive polymer can be an alkali metal or alkaline earth metal compound that dissociates to give metal ions. Examples of alkali metal compounds include lithium compounds, sodium compounds, and potassium compounds. Examples of alkaline earth metal compounds include magnesium compounds and calcium compounds. The solvent for the solution of the metal compound can be of any kind that dissolves the metal compound and does not dissolve the polymeric electrolyte. As mentioned herein, alkaline earth metals include magnesium. With any of these compounds, a flow battery is realized that has a large charge capacity and maintains its charge-discharge characteristics for an extended period of time.

The first nonaqueous liquid 110 in the flow battery 1000 according to Embodiment 1 may contain, as a solvent, a compound that has at least one selected from the group consisting of a carbonate group and an ether group. The first nonaqueous liquid 110 may be a compound that has at least one selected from the group consisting of a carbonate group and an ether group.

Examples of compounds having a carbonate group include propylene carbonate (PC), ethylene carbonate (EC), dimethyl carbonate (DMC), ethyl methyl carbonate (EMC), and diethyl carbonate (DEC). At least one selected from the group consisting of these can be used as solvent(s).

Examples of compounds having an ether group include dimethoxyethane, diethoxyethane, dibutoxyethane, diglyme (diethylene glycol dimethyl ether), triglyme (triethylene glycol dimethyl ether), tetraglyme (tetraethylene glycol dimethyl ether), polyethylene glycol dialkyl ethers, tetrahydrofuran, 2-methyltetrahydrofuran, 2,5-dimethyltetrahydrofuran, 1,3-dioxolane, and 4-methyl-1,3-dioxolane. At least one selected from the group consisting of these can be used as solvent(s).

The first nonaqueous liquid 110 in the flow battery 1000 according to Embodiment 1 may be an electrolyte containing at least one electrolytic substance. The electrolytic substance may be at least one salt selected from the group consisting of LiBF₄, LiPF₆, LiTFSI (lithium bis(trifluoromethanesulfonyl)imide), LiFSI (lithium bis(fluorosulfonyl)imide), LiCF₃SO₃, LiClO₄, NaBF₄, NaPF₆, NaTFSI, NaFSI, NaCF₃SO₃, NaClO₄, Mg(BF₄)₂, Mg(PF₆)₂, Mg(TFSI)₂, Mg(FSI)₂, Mg(CF₃SO₃)₂, Mg(ClO₄)₂, AlCl₃, AlBr₃, and Al(TFSI)₃. The first nonaqueous liquid 110 may have a high dielectric constant and may be only weakly reactive with metal ions. The electrochemical window of the first nonaqueous liquid 110, furthermore, may be narrower than or equal to approximately 4 V.

The first electrode mediator 111 in the flow battery 1000 according to Embodiment 1 can be a substance that dissolves in the first nonaqueous liquid 110 and is electrochemically oxidized and reduced there. Examples of first electrode mediators 111 include ions or complexes of multivalent metals, typically metals such as vanadium, iron, and chromium. The first electrode mediator 111 may be a heterocyclic compound, such as a tetrathiafulvalene derivative, a bipyridyl derivative, a thiophene derivative, a thianthrene derivative, a carbazole derivative, or phenanthroline. The first electrode mediator 111 may be an oxocarbon. The first electrode mediator 111 may be an aromatic ketone, such as benzophenone, acetophenone, butyrophenone, and valerophenone. The first electrode mediator 111 may be an aromatic compound, such as biphenyl, phenanthrene, trans-stilbene, cis-stilbene, triphenylene, o-terphenyl, m-terphenyl, p-terphenyl, anthracene, benzophenone, acetophenone, butyrophenone, valerophenone, acenaphthene, acenaphthylene, fluoranthene, or benzil. The first electrode mediator 111 may be a metallocene compound, such as ferrocene. Optionally, two or more of such first electrode mediator 111 may be used in combination. The molecular weight of the first electrode mediator 111 is not critical. For example, the molecular weight of the first electrode mediator is larger than or equal to 100 and smaller than or equal to 300.

Incidentally, the first electrode 210, in the flow battery 1000 according to Embodiment 1, may be the positive electrode, and the second electrode 220 may be the negative electrode.

The first electrode 210, however, can be the negative electrode if the second electrode 220 is a relatively high-potential electrode. That is, it may be that the first electrode 210 is the negative electrode with the second electrode 220 being the positive electrode.

In the flow battery 1000 according to Embodiment 1, furthermore, the first electrode mediator 111 is oxidized or reduced by the first electrode 210, for example through the contact of the first nonaqueous liquid 110 with the first electrode 210.

The first electrode 210 may be an electrode having a surface that acts as a reaction field for the first electrode mediator 111.

In this case, the first electrode 210 can be made of a material stable against the first nonaqueous liquid 110. The material stable against the first nonaqueous liquid 110 may be, for example, a material insoluble in the first nonaqueous liquid 110. In addition, the first electrode 210 can be made of a material stable against the electrochemical reactions that occur at the electrode. For example, the first electrode 210 can be a piece of metal or carbon. The metal may be, for example, stainless steel, iron, copper, or nickel.

The first electrode 210 may be one structured to have an increased surface area. The electrode structured to have an increased surface area may be, for example, a piece of mesh, a piece of nonwoven fabric, a plate with a roughened surface, or a sintered porous medium. This increases the specific surface area of the first electrode 210. The oxidation or reduction of the first electrode mediator 111 proceeds more efficiently in consequence.

The second electrode 220 can be, for example, an electrode as described by way of example in relation to the first electrode 210. The first and second electrodes 210 and 220 may be electrodes made of different materials or may be electrodes made of the same material.

The structure of the second electrode 220 may include a current collector and an active material disposed on the current collector. This allows, for example, the use of a high-capacity active material. The active material for the second electrode 220 can be a compound capable of reversibly storing and releasing lithium ions.

Alternatively, the second electrode 220 may be a piece of lithium metal. If the second electrode 220 is a piece of lithium metal, it is easy to control the dissolution and separation of this electrode as a metallic negative electrode. Using such an electrode also helps achieve a high capacity.

The flow battery 1000 may further include a first active material 310 immersed in the first nonaqueous liquid 110. The first active material 310 can be a substance that chemically oxidizes and reduces the first electrode mediator 111. The first active material 310 is, for example, insoluble in the first nonaqueous liquid 110.

The first active material 310 can be a compound capable of reversibly storing and releasing metal ions. By selecting a low- or high-potential compound as the first active material 310 according to the electrical potential of the first electrode mediator 111, the flow battery 1000 is made to operate.

Examples of low-potential compounds that can act as the first active material 310 include metals, metal oxides, carbon, and silicon. Examples of metals include lithium, sodium, magnesium, aluminum, and tin. Examples of metal oxides include titanium oxide. In particular, in a system in which the first electrode mediator 111 is an aromatic compound and in which lithium is dissolved in the first nonaqueous liquid 110, the low-potential compound can be a compound that contains at least one selected from the group consisting of carbon, silicon, aluminum, and tin.

Examples of high-potential compounds that can act as the first active material 310 include metal oxides such as lithium iron phosphate, LCO (LiCoO₂), LMO (LiMn₂O₄), and NCA (lithium nickel cobalt aluminum oxides).

By employing a configuration in which a first active material 310 chemically oxidizes and reduces the first electrode mediator 111, it is ensured that the charge-discharge capacity of the flow battery 1000 depends not on the solubility of the first electrode mediator 111 but on the capacity of the first active material 310. As a result, a flow battery 1000 is realized that has a high energy density.

### Description of the Charging and Discharging Processes

The processes of charge and discharge of the flow battery 1000 according to Embodiment 1 are described below.

Specifically, an operation example configured as described below is described by way of example to illustrate the charging and discharging processes.

The first electrode 210 is the positive electrode and is a piece of carbon black.

The first nonaqueous liquid 110 is an ether solution in which the first electrode mediator 111 is dissolved.

The first electrode mediator 111 is tetrathiafulvalene (hereinafter described as TTF).

The first active material 310 is lithium iron phosphate (hereinafter described as LiFePO₄).

The second electrode 220 is the negative electrode and is a piece of lithium metal.

### Description of the Charging Process

First, charging reactions are described.

The battery 1000 is charged through the application of a voltage across the first and second electrodes 210 and 220.

### Reaction at the Negative Electrode

The application of a voltage causes electrons to be supplied to the second electrode 220, which is the negative electrode, from the outside of the flow battery 1000. At the second electrode 220, which is the negative electrode, reduction occurs in consequence. The negative electrode therefore goes into its charged state.

In this operation example, for instance, the following reaction takes place.

Li⁺+e⁻→Li

### Reactions at the Positive Electrode

At the first electrode 210, which is the positive electrode, the application of a voltage causes the oxidation of the first electrode mediator 111. That is, the first electrode mediator 111 is oxidized on the surface of the first electrode 210. Electrons are released from the first electrode 210 to the outside of the flow battery 1000 in consequence.

In this operation example, for instance, the following reaction takes place.

TTF→TTF²⁺+2e⁻

The first electrode mediator 111 oxidized at the first electrode 210 is reduced by the first active material 310. In other words, the first active material 310 is oxidized by the first electrode mediator 111.

2LiFePO₄+TTF²⁺→2FePO⁴+2Li⁺+TTF

These charging reactions can proceed until the first active material 310 goes into its charged state or the second electrode 220 goes into its charged state, whichever is reached first.

### Description of the Discharging Process

Next, discharging reactions are described.

The first active material 310 and the second electrode 220 are in their charged state.

In the discharging reactions, electricity is taken out from between the first and second electrodes 210 and 220.

### Reaction at the Negative Electrode

At the second electrode 220, which is the negative electrode, oxidation occurs. The negative electrode therefore goes into its discharged state. Electrons are released from the second electrode 220 to the outside of the flow battery 1000 in consequence.

In this operating example, for instance, the following reaction takes place.

Li→Li⁺+e⁻

### Reactions at the Positive Electrode

The battery discharge causes electrons to be supplied to the first electrode 210, which is the positive electrode, from the outside of the flow battery 1000. On the first electrode 210, the reduction of the first electrode mediator 111 occurs in consequence. That is, the first electrode mediator 111 is reduced on the surface of the first electrode 210.

In this operation example, for instance, the following reaction takes place.

TTF²⁺+2e⁻→TTF

Some of the lithium ions (Li⁺) are supplied from the second electrode 220 side through the separator 400.

The first electrode mediator 111 reduced at the first electrode 210 is oxidized by the first active material 310. In other words, the first active material 310 is reduced by the first electrode mediator 111.

2FePO₄+2Li⁺+TTF→2LiFePO₄+TTF²⁺

These discharging reactions can proceed until the first active material 310 goes into its discharged state or the second electrode 220 goes into its discharged state, whichever is reached first.

If the first active substance 310 is omitted, the first electrode mediator 111 plays the role of an active substance.

### Embodiment 2

In the following, Embodiment 2 is described. Any details that have already been described in Embodiment 1 above are omitted where appropriate.

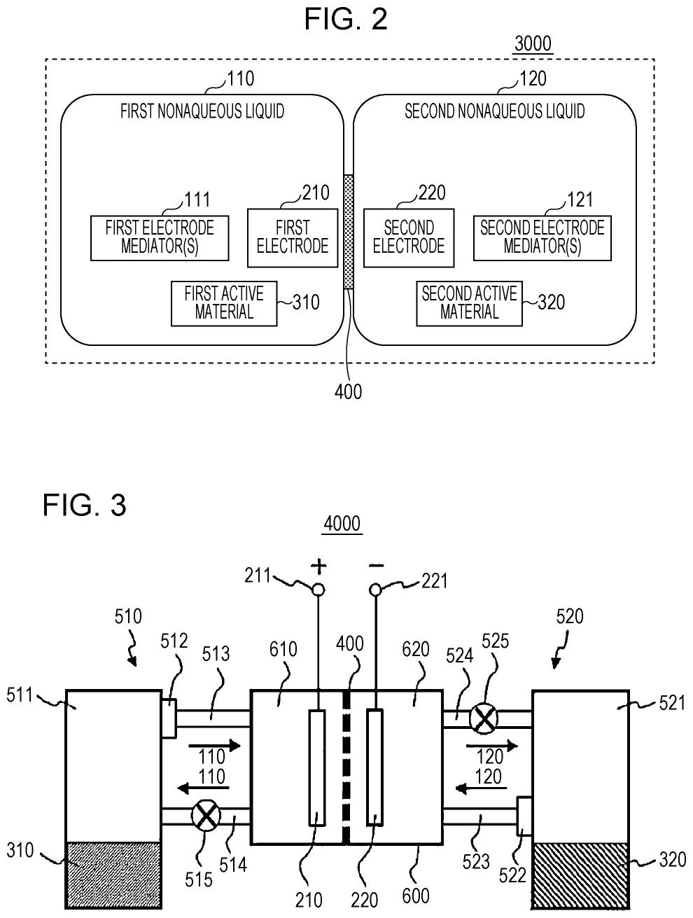

FIG. 2 is a block diagram illustrating an outline structure of a flow battery 3000 according to Embodiment 2 by way of example.

Besides having the configuration of the flow battery 1000 according to Embodiment 1 above, the flow battery 3000 according to Embodiment 2 is configured as described below.

That is, the flow battery 3000 according to Embodiment 2 further includes a second nonaqueous liquid 120, at least one second electrode mediator 121, and a second active material 320.

The second nonaqueous liquid 120 contains the second electrode mediator 121 and metal ions dissolved therein.

At least part of the second electrode 220 is in contact with the second nonaqueous liquid 120.

The separator 400 separates the first and second electrodes 210 and 220 from each other. The separator 400 also separates the first and second nonaqueous liquids 110 and 120 from each other.

The separator 400 can be made of an ion conductive polymer as described in Embodiment 1. The separator 400 therefore does not easily swell even if it comes into contact with the first nonaqueous liquid 110 or second nonaqueous liquid 120, and conducts metal ions. By virtue of this, greater flexibility is allowed in selecting the first nonaqueous liquid 110, the first electrode mediator 111, the second nonaqueous liquid 120, and the second electrode mediator 121. The limits to which the charge and discharge potentials should be controlled are therefore expanded, helping increase the charge capacity of the flow battery 3000. The separator 400, furthermore, keeps the first and second nonaqueous liquids 110 and 120 separate and prevents them from mixing together even if the two liquids have different compositions, allowing the flow battery 3000 to maintain its charge-discharge characteristics for an extended period of time.

In this configuration, a flow battery is realized that has a large charge capacity and maintains its charge-discharge characteristics for an extended period of time.

The second nonaqueous liquid 120 in the flow battery 3000 can be, like the first nonaqueous liquid 110, a nonaqueous liquid that has a carbonate group and/or an ether group. The second nonaqueous liquid 120 may be the same kind of nonaqueous liquid as the first nonaqueous liquid 110 or may be a different kind of nonaqueous liquid.

The second electrode mediator 121 in the flow battery 3000 can be a substance that dissolves in the second nonaqueous liquid 120 and is electrochemically oxidized and reduced there. Specific examples of substances that can be used as the second electrode mediator 121 are the same kinds of metal-containing ionic compounds and organic compounds as mentioned in relation to the first electrode mediator 111. The second electrode mediator 121 includes, for example, at least one selected from the group consisting of tetrathiafulvalene, triphenylamine, and derivatives thereof. By selecting low- and high-potential compounds for use as the first and second electrode mediators 111 and 121, respectively, the flow battery 3000 is made to operate.

The first active material 310 in the flow battery 3000 can be, for example, a substance that does not dissolve in the first nonaqueous liquid 110 and chemically oxidizes and reduces the first electrode mediator 111. Like the first active material 310, the second active material 320 can be, for example, a substance that does not dissolve in the second nonaqueous liquid 120 and chemically oxidizes and reduces the second electrode mediator 121. That is, each of the first and second active materials 310 and 320 can be a compound capable of reversibly storing and releasing metal ions. By using a low-potential compound as one of the first and second active materials 310 and 320 and using a high-potential compound as the other in accordance with the electrical potentials of the first and second electrode mediators 111 and 121, the flow battery 3000 is made to operate.

Examples of low- and high-potential compounds that can act as the second active material 320 are the same as mentioned by way of example in relation to the first active material 310.

By employing a configuration in which first and second active materials 310 and 320 chemically oxidize and reduce the first and second electrode mediators 111 and 121, respectively, it is ensured that the charge-discharge capacity of the flow battery 3000 depends not on the solubility of the first and second electrode mediators 111 and 121 but on the capacity of the first and second active materials 310 and 320. As a result, a flow battery 3000 is realized that has a high energy density.

If the second active material 320 is omitted, the second electrode mediator 121 plays the role of an active material.

### Embodiment 3

In the following, Embodiment 3 is described. Any details that have already been described in Embodiment 1 or 2 above are omitted where appropriate.

FIG. 3 is a schematic diagram illustrating an outline structure of a flow battery 4000 according to Embodiment 3 by way of example.

Besides having the configuration of the flow battery 3000 according to Embodiment 2 above, the flow battery 4000 according to Embodiment 3 is configured as described below.

That is, the flow battery 4000 according to Embodiment 3 includes a first circulator 510.

The first circulator 510 is a mechanism that circulates the first nonaqueous liquid 110 between the first electrode 210 and the first active material 310.

The first circulator 510 includes a first container 511. The first circulator 510 includes piping 513, piping 514, and a pump 515. The pump 515 is, for example, provided on the piping 514. Alternatively, the pump 515 may be provided on the piping 513.

The first active material 310 and the first nonaqueous liquid 110 are contained in the first container 511.

In the first container 511, the first active material 310 and the first nonaqueous liquid 110 come into contact with each other, and at least one of the following is carried out in consequence: the oxidation of the first electrode mediator 111 by the first active material 310 or the reduction of the first electrode mediator 111 by the first active material 310.

In this configuration, the first nonaqueous liquid 110 and the first active material 310 are brought into contact with each other in a first container 511. This helps, for example, increase the area of contact between the first nonaqueous liquid 110 and the first active material 310. The duration of contact between the first nonaqueous liquid 110 and the first active material 310 also becomes longer. As a result, the oxidation and reduction of the first electrode mediator 111 by the first active material 310 are carried out more efficiently.

In Embodiment 3, the first container 511 may be, for example, a tank.

The first container 511 may be, for example, filled with particles of the first active material 310, and the first nonaqueous liquid 110 may be held in the spaces between the particles of the first active material 310 with the first electrode mediator 111 dissolved therein.

As illustrated in FIG. 3, the flow battery 4000 according to Embodiment 3 further includes an electrochemical reaction section 600, a positive electrode terminal 211, and a negative electrode terminal 221.

The electrochemical reaction section 600 is separated by the separator 400 into a positive electrode compartment 610 and a negative electrode compartment 620.

In the positive electrode compartment 610 is the electrode that serves as the positive electrode. In FIG. 3, the first electrode 210 is in the positive electrode compartment 610. At least part of the first electrode 210 is in contact with the first nonaqueous liquid 110.

The positive electrode terminal 211 is coupled to the electrode that serves as the positive electrode. In FIG. 3, the positive electrode terminal 211 is coupled to the first electrode 210.

In the negative electrode compartment 620 is the electrode that serves as the negative electrode. In FIG. 3, the second electrode 220 is in the negative electrode compartment 620. At least part of the second electrode 220 is in contact with the second nonaqueous liquid 120.

The negative electrode terminal 221 is coupled to the electrode that serves as the negative electrode. In FIG. 3, the negative electrode terminal 221 is coupled to the second electrode 220.

The positive electrode and negative electrode terminals 211 and 221 are coupled to, for example, a charger/discharger. By the charger/discharger, either a voltage is applied across the positive electrode and negative electrode terminals 211 and 221 or electricity is taken out from between the positive electrode and negative electrode terminals 211 and 221.

One end of the piping 513 is connected to an outlet on the first container 511 for the first nonaqueous liquid 110 to flow out.

The other end of the piping 513 is connected to one of the positive electrode and negative electrode compartments 610 and 620, whichever the first electrode 210 is in. In FIG. 3, this end of the piping 513 is connected to the positive electrode compartment 610.

One end of the piping 514 is connected to one of the positive electrode and negative electrode compartments 610 and 620, whichever the first electrode 210 is in. In FIG. 3, this end of the piping 514 is connected to the positive electrode compartment 610.

The other end of the piping 514 is connected to an inlet on the first container 511 for the first nonaqueous liquid 110 to flow out.

The first circulator 510 in the flow battery 4000 according to Embodiment 3 may include a first penetration limiter 512.

The first penetration limiter 512 limits the penetration of the first active material 310.

The first penetration limiter 512 is provided in the channel through which the first nonaqueous liquid 110 flows out of the first container 511 toward the first electrode 210. In FIG. 3, the first penetration limiter 512 is on the piping 513. The first penetration limiter 512, however, may be provided at the joint between the first container 511 and the piping 514. Alternatively, the first penetration limiter 512 may be at the joint between the electrochemical reaction section 600 and the piping 513 or at the joint between the electrochemical reaction section 600 and the piping 514.

In this configuration, the outflow of the first active material 310 somewhere other than the first container 511 is reduced. For example, the outflow of the first active material 310 toward the first electrode 210 is reduced. The first active material 310 stays in the first container 511 in consequence. By virtue of this, a flow battery is realized in which the first active material 310 itself is not allowed to circulate. The components of the first circulator 510 are therefore prevented from getting clogged inside with the first active material 310. For example, the piping in the first circulator 510 is prevented from getting clogged inside with the first active material 310. A loss due to resistance caused by the outflow of the first active material 310 toward the first electrode 210 becomes less frequent.

The first penetration limiter 512 may be, for example, a filter that filters out the first active material 310. The filter in this case may be a component that has pores smaller than the smallest diameter of the particles of the first active material 310. The material for the filter can be one that does not react with the first active material 310, the first nonaqueous liquid 110, etc. The filter may be, for example, a piece of glass-fiber filter paper, a piece of polypropylene nonwoven fabric, a piece of polyethylene nonwoven fabric, a polyethylene separator, a polypropylene separator, a polyimide separator, a polyethylene/polypropylene bilayer separator, a polypropylene/polyethylene/polypropylene three-layer separator, or a piece of metal mesh that does not react with metallic lithium.

In this configuration, the first active material 310 is prevented from flowing out of the first container 511 even if the first active material 310 flows together with the first nonaqueous liquid 110 inside the first container 511.

In FIG. 3, the first nonaqueous liquid 110 contained in the first container 511 is supplied to the positive electrode compartment 610 by passing through the first penetration limiter 512 and the piping 513.

The first electrode mediator 111, dissolved in the first nonaqueous liquid 110, is oxidized or reduced by the first electrode 210 in consequence.

Then the first nonaqueous liquid 110, with the oxidized or reduced first electrode mediator 111 dissolved therein, is supplied to the first container 511 by passing through the piping 514 and the pump 515.

As a result, the first electrode mediator 111, dissolved in the first nonaqueous liquid 110, is subjected to at least one of the following: the oxidation or reduction of the first electrode mediator 111 by the first active material 310.

The way to control the circulation of the first nonaqueous liquid 110 may be with the use of, for example, the pump 515. That is, the pump 515 may be used to start and stop the supply of the first nonaqueous liquid 110 or to make adjustments, for example to the rate of supply of the first nonaqueous liquid 110, on an as-needed basis.

The way to control the circulation of the first nonaqueous liquid 110 does not need to be with the pump 515 and may be with another tool. Such a tool may be, for example, a valve.

It should be noted that in FIG. 3, the first electrode 210 is the positive electrode by way of example, with the second electrode 220 being the negative electrode.

The first electrode 210, however, can be the negative electrode if the second electrode 220 is a relatively high-potential electrode.

That is, it may be that the first electrode 210 is the negative electrode with the second electrode 220 being the positive electrode.

The electrolyte and/or solvent composition(s), furthermore, may be different across the separator 400, or between the positive electrode compartment 610 and negative electrode compartment 620 sides.

The electrolyte and/or solvent composition(s) may be the same on both the positive electrode compartment 610 and negative electrode compartment 620 sides.

The flow battery 4000 according to Embodiment 3 further includes a second circulator 520.

The second circulator 520 is a mechanism that circulates the second nonaqueous liquid 120 between the second electrode 220 and the second active material 320.

The second circulator 520 includes a second container 521. The second circulator 520 includes piping 523, piping 524, and a pump 525. The pump 525 is, for example, provided on the piping 524. Alternatively, the pump 525 may be provided on the piping 523.

The second active material 320 and the second nonaqueous liquid 120 are contained in the second container 521.

The second active material 320 and the second nonaqueous liquid 120 come into contact with each other in the second container 521, and at least one of the following is carried out in consequence: the oxidation of the second electrode mediator 121 by the second active material 320 or the reduction of the second electrode mediator 121 by the second active material 320.

In this configuration, the second nonaqueous liquid 120 and the second active material 320 are brought into contact with each other in a second container 521. This helps, for example, increase the area of contact between the second nonaqueous liquid 120 and the second active material 320. The duration of contact between the second nonaqueous liquid 120 and the second active material 320 also becomes longer. As a result, at least one of the oxidation or reduction of the second electrode mediator 121 by the second active material 320 is carried out more efficiently.

In Embodiment 3, the second container 521 may be, for example, a tank.

The second container 521 may be, for example, filled with particles of the second active material 320, and the second nonaqueous liquid 120 may be held in the spaces between the particles of the second active material 320 with the second electrode mediator 121 dissolved therein.

One end of the piping 523 is connected to an outlet on the second container 521 for the second nonaqueous liquid 120 to flow out.

The other end of the piping 523 is connected to one of the positive electrode and negative electrode compartments 610 and 620, whichever the second electrode 220 is in. In FIG. 3, this end of the piping 523 is connected to the negative electrode compartment 620.

One end of the piping 524 is connected to one of the positive electrode and negative electrode compartments 610 and 620, whichever the second electrode 220 is in. In FIG. 3, this end of the piping 524 is connected to the negative electrode compartment 620.

The other end of the piping 524 is connected to an inlet on the second container 521 for the second nonaqueous liquid 120 to flow out.

The second circulator 520 in the flow battery 4000 according to Embodiment 3 may include a second penetration limiter 522.

The second penetration limiter 522 limits the penetration of the second active material 320.

The second penetration limiter 522 is provided in the channel through which the second nonaqueous liquid 120 flows out of the second container 521 toward the second electrode 220. In FIG. 3, the second penetration limiter 522 is on the piping 523. The second penetration limiter 522, however, may be provided at the joint between the second container 521 and the piping 524. Alternatively, the second penetration limiter 522 may be at the joint between the electrochemical reaction section 600 and the piping 523 or at the joint between the electrochemical reaction section 600 and the piping 524.

In this configuration, the outflow of the second active material 320 somewhere other than the second container 521 is reduced. For example, the outflow of the second active material 320 toward the second electrode 220 is reduced. The second active material 320 stays in the second container 521 in consequence. By virtue of this, a flow battery is realized in which the second active material 320 itself is not allowed to circulate. The components of the second circulator 520 are therefore prevented from getting clogged inside with the second active material 320. For example, the piping in the second circulator 520 is prevented from getting clogged inside with the second active material 320. A loss due to resistance caused by the outflow of the second active material 320 toward the second electrode 220 becomes less frequent.

The second penetration limiter 522 may be, for example, a filter that filters out the second active material 320. The filter in this case may be a component that has pores smaller than the smallest diameter of the particles of the second active material 320. The material for the filter can be one that does not react with the second active material 320, the second nonaqueous liquid 120, etc. The filter may be, for example, a piece of glass-fiber filter paper, a piece of polypropylene nonwoven fabric, a piece of polyethylene nonwoven fabric, or a piece of metal mesh that does not react with metallic lithium.

In this configuration, the second active material 320 is prevented from flowing out of the second container 521 even if the second active material 320 flows together with the second nonaqueous liquid 120 inside the second container 521.

In the example illustrated in FIG. 3, the second nonaqueous liquid 120 contained in the second container 521 is supplied to the negative electrode compartment 620 by passing through the second penetration limiter 522 and the piping 523.

The second electrode mediator 121, dissolved in the second nonaqueous liquid 120, is oxidized or reduced by the second electrode 220 in consequence.

Then the second nonaqueous liquid 120, with the oxidized or reduced second electrode mediator 121 dissolved therein, is supplied to the second container 521 by passing through the piping 524 and the pump 525.

As a result, the second electrode mediator 121, dissolved in the second nonaqueous liquid 120, is subjected to at least one of the following: the oxidation or reduction of the second electrode mediator 121 by the second active material 320.

The way to control the circulation of the second nonaqueous liquid 120 may be with the use of, for example, the pump 525. That is, the pump 525 may be used to start and stop the supply of the second nonaqueous liquid 120 or to make adjustments, for example to the rate of supply of the second nonaqueous liquid 120, on an as-needed basis.

The way to control the circulation of the second nonaqueous liquid 120 does not need to be with the pump 525 and may be with another tool. Such a tool may be, for example, a valve.

It should be noted that in FIG. 3, the first electrode 210 is the positive electrode by way of example, with the second electrode 220 being the negative electrode.

The second electrode 220, however, can be the positive electrode if the first electrode 210 is a relatively low-potential electrode.

That is, it may be that the second electrode 220 is the positive electrode with the first electrode 210 being the negative electrode.

The configurations described in each of Embodiments 1 to 3 above may optionally be combined with one another.

Another embodiment of an aspect of the present disclosure is a separating element for flow batteries. The separating element includes an ion conductive polymer that has a crosslink structure including an aromatic ring. The ion conductive polymer has an alkyl main chain that includes a plurality of acidic groups, and at least a subset of the plurality of acidic groups is in the form of a salt with at least one species of metal ion. This separating element corresponds to the separator 400 described in each of Embodiments 1 to 3 above.

### EXAMPLES

The following describes the present disclosure by providing examples. The present disclosure, however, is by no means limited to these examples. Many variations can be made by those ordinarily skilled in the art within the technical scope of the present disclosure.

### Preparation of a First Liquid

A lithium-biphenyl solution, in which biphenyl, an aromatic compound that can be used as a first electrode mediator, and metallic lithium were dissolved, was used as a first liquid (first nonaqueous liquid). This first liquid was prepared following the procedure described below.

First, biphenyl and LiPF₆, which is an electrolytic salt, were dissolved in triglyme, a first nonaqueous solvent. The concentration of biphenyl in the resulting solution was 0.1 mol/L. The concentration of LiPF₆ in the solution was 1 mol/L. To this solution, an excess of metallic lithium was added. The metallic lithium was dissolved until saturation, giving a deep-blue biphenyl solution saturated with lithium. The surplus metallic lithium remained as a precipitate. The supernatant of this biphenyl solution was therefore used as a first liquid.

### Preparation of a Second Liquid

Tetrathiafulvalene, which was a second electrode mediator, and LiPF₆, an electrolytic salt, were dissolved in triglyme, a second nonaqueous solvent. The resulting solution was used as a second liquid (second nonaqueous liquid). The concentration of tetrathiafulvalene in the second liquid was 5 mmol/L. The concentration of LiPF₆ in the second liquid was 1 mol/L.

### Construction of a Test System

The separator of Example 1, Comparative Example 1, or Comparative Example 2, described below, was set in an electrochemical cell. One milliliter each of the first and second liquids were put into the electrochemical cell, separated from each other by the separator. A first electrode was immersed in the first liquid, and a second electrode in the second liquid. The first and second electrodes were stainless steel foams. The open-circuit voltage was measured for 10 hours using an electrochemical analyzer.

### Example 1

The separator of sample 1 was a SELEMION membrane (Asahi Glass; SELEMION CMV). Ion exchange was carried out by immersing the SELEMION membrane in a 1 mol/L aqueous solution of lithium hydroxide. The membrane was then washed with water to give a polymeric membrane holding lithium ions.

### Comparative Example 1

A polymeric membrane for use as a separator was obtained in the same way as in Example 1, except that a Nafion® 117 polymeric membrane was used.

### Comparative Example 2

The separator was a polypropylene/polyethylene/polypropylene three-layer separator membrane.

Table 1 presents the decrease in the open-circuit voltage of the electrochemical cell for Example 1, Comparative Example 1, and Comparative Example 2. To be exact, the table presents the decrease in open-circuit voltage at 10 hours after the open-circuit voltage peaked.

TABLE 1

| | | Comparative | Comparative |
|---|---|---|---|
| | Example | Example 1 | Example 2 |
| Separator | SELEMION | Nafion | Polypropylene/polyethylene/ |
| | membrane | 117 | polypropylene three-layer |
| | | | separator membrane |
| Decrease in | 14.0 mV | 187 mV | 988 mV |
| open-circuit | | | |
| voltage | | | |

The electrochemical cell of Examples 1 lost little of its open-circuit voltage within 10 hours after the peak, indicating that the mixing of the first and second liquids was mild in the electrochemical cell of Example 1. The crossover of mediators, in other words, was mild, presumably because the electrochemical cell of Example 1 experienced little swelling of the ion conductive polymer forming the separator 400. The electrochemical cells of Comparative Examples 1 and 2, by contrast, experienced a significant loss of open-circuit voltage, suggesting that the mixing of the first and second liquids occurred in the electrochemical cells of Comparative Examples 1 and 2.

The flow battery according to an aspect of the present disclosure is suitable for use as, for example, a device or system for electricity storage.

What is claimed is:

1. A flow battery comprising:
a first nonaqueous liquid;
a first electrode at least in part in contact with the first nonaqueous liquid;
a second electrode that is a counter electrode with respect to the first electrode; and
a separator that separates the first electrode and the second electrode from each other, wherein:
the separator is made of an ion conductive polymer that has a crosslink structure containing an aromatic ring;
the ion conductive polymer has an alkyl main chain that contains a plurality of acidic groups; and
at least a subset of the plurality of the acidic groups forms salts with metal ions.

2. The flow battery according to claim 1, wherein the metal ions include at least one species selected from the group consisting of alkali metal ions and alkaline earth metal ions.

3. The flow battery according to claim 1, wherein the metal ions include at least one species selected from the group consisting of lithium ions, sodium ions, potassium ions, magnesium ions, and calcium ions.

4. The flow battery according to claim 3, wherein the metal ions are lithium ions.

5. The flow battery according to claim 1, wherein the acidic groups include at least one selected from the group consisting of a sulfo group, a carboxyl group, a trifluoromethanesulfonylimide group, a fluorosulfonylimide group, a fluorosulfonic acid group, a phosphonic acid group, a fluorophosphonic acid group, and a phosphoric acid group.

6. The flow battery according to claim 5, wherein the acidic groups include the sulfo group.

7. The flow battery according to claim 1, wherein the ion conductive polymer includes a structure represented by general formula (1), 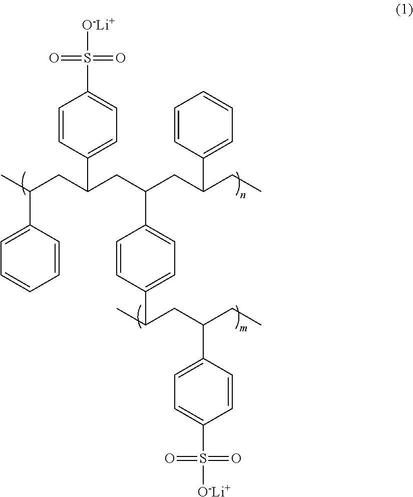
where m and n are each independently an integer larger than or equal to 1.

8. The flow battery according to claim 1, wherein the first nonaqueous liquid contains, as a solvent, a compound that has at least one selected from the group consisting of a carbonate group and an ether group.

9. The flow battery according to claim 1, wherein the first nonaqueous liquid contains, as a solvent, at least one selected from the group consisting of propylene carbonate, ethylene carbonate, dimethyl carbonate, ethyl methyl carbonate, and diethyl carbonate.

10. The flow battery according to claim 1, wherein the first nonaqueous liquid contains, as a solvent, at least one selected from the group consisting of dimethoxyethane, dibutoxyethane, diglyme, triglyme, tetraglyme, tetrahydrofuran, 2-methyltetrahydrofuran, 2,5-dimethyltetrahydrofuran, 1,3-dioxolane, and 4-methyl-1,3-dioxolane.

11. The flow battery according to claim 1, further comprising:
a first electrode mediator;
a first active material; and
a first circulator configured to circulate the first nonaqueous liquid between the first electrode and the first active material, wherein:
the first nonaqueous liquid contains the first electrode mediator;
the first electrode mediator is oxidized or reduced by the first electrode; and
the first electrode mediator is oxidized or reduced by the first active material.

12. The flow battery according to claim 1, further comprising:
a second nonaqueous liquid;
a second electrode mediator;
a second active material; and
a second circulator configured to circulate the second nonaqueous liquid between the second electrode and the second active material, wherein:
the second nonaqueous liquid contains the second electrode mediator;
at least part of the second electrode is in contact with the second nonaqueous liquid;
the second electrode mediator is oxidized or reduced by the second electrode; and
the second electrode mediator is oxidized or reduced by the second active material.
